(19) United States
(12) Patent Application Publication
(10) Pub. No.: US 2007/0086773 A1
(43) Pub. Date: Apr. 19, 2007

(54) Method for creating and operating a user interface

(76) Inventors: Fredrik Ramsten, Malmo (SE); Emil Hansson, Malmo (SE)

Correspondence Address: MYERS BIGEL SIBLEY & SAJOVEC, P.A., P.O. BOX 37428, RALEIGH, NC, 27627, US

(21) Appl. No.: 11/250,883

(22) Filed: Oct. 14, 2005

(51) Int. Cl. G03B 17/18; G03B 19/00

(52) U.S. Cl. 396/287; 396/429

(57) ABSTRACT

Method and computer program products for creating and using a graphical user interface of an electronic device are provided. In some methods, a photograph is provided as a digital image, and a segment of the image is defined as an image button, by linking an action to coordinate data of the segment, to be carried out by the electronic device responsive to clicking on the image button. The segment representing the clickable area for the image button may be defined by running an image segmentation application on the digital image to define separate segments covering objects depicted in the photograph. The action to be carried out may be associated with the object, such as a person, covered by the image button, such as presenting information about the object or initiating communication with a communication address associated with the object.

### FIELD OF THE INVENTION

The present invention relates to methods for managing, detecting, or controlling actions and events using a segmented image as an input or output interface for use with, for example, electronic devices with communication capabilities, including, but not limited to, mobile phones, network-connected computers, and in home equipment such as programmable remote controls.

### BACKGROUND OF THE INVENTION

Electronic devices such as mobile phones and computers typically include both a user input interface in the form of keys or buttons, and a user output interface in the form of one or more displays. Audio interfaces are normally also included by means of speakers and microphones, which may also be used for voice control of actions or selections in the electronic device, provided that appropriate software is installed. However, data or information output is predominately effected by means of a graphical user interface including the display.

Graphical user interfaces are in general an abstract version of reality, e.g. a person can be represented as a phone number in a list of other phone numbers representing other persons. This is good for efficiency and administrative reasons, if you can read. However, this abstraction means that other qualities of reality are lost, special moments in daily life or temporary constellations of groups of persons are more difficult to manifest in a mobile device.

In recent years it has become very popular to personalize the look of your mobile phone. The introduction of color displays drastically increases the number of areas you could personalize. For some time it has been possible to associate a ring signal with a contact in the phone book. In computer games and discussion forums on the Internet the usage of so called avatars can also be seen for representation of users, where e.g. a cartoon image of a head is used to represent a user.

Today, high resolution color displays are included even in very compact electronic devices, such as mobile phones, and more and more often a digital camera is either included or connectable to the electronic device for capturing pictures and presenting them on the display. Using e.g. email, MMS, or a memory stick, a digital image stored in an electronic device may be transferred or transmitted to other user devices for sharing or printout. Actually using images shown on a display of an electronic device has, however, been restricted to pure presentation of the image itself, or for video conferencing with video.

### SUMMARY OF THE INVENTION

An improved way of managing actions or events related to persons, places or other objects captured in a photograph is provided, wherein a digital image of the photograph, presentable on a display of an electronic device, is segmented such that a segment of the image is set to act as a button for the purpose of inputting or outputting information or control signals. This provides an intuitive and straightforward way of controlling actions relating to concrete objects which may be represented by an image.

According to a first embodiment of the invention, a method for creating a user interface for an electronic device, includes providing a photograph as a digital image, defining an image area which is a segment of the digital image, and defining an image button by linking. an action to the image area, to be carried out responsive to activation of the image area when the image is presented on a display.

According to a further embodiment, defining the image area includes running an image segmentation application on the digital image to define separate segments covering objects depicted in the photograph, and selecting a segment identified by the image segmentation as the image area.

According to a further embodiment, defining the image. area includes placing one or more image area marking items in the image, and defining the image area as the area covered by the one or more image area marking items.

According to a further embodiment, an object is depicted in the image area of the image button, and the method further includes storing computer program code for the image button, including data associated with the object.

According to a further embodiment, the action includes presentation of information relating to the data associated with the object.

According to a further embodiment, the information includes a communication address associated with the object.

According to a further embodiment, the data includes a communication address associated with the object, and the action to be carried out includes initiating communication from the electronic device to the communication address.

According to a further embodiment, the object is a person, and the computer program code includes a virtual business card for the person.

According to a further embodiment, the method further includes storing computer program code, including a tag including image data for the digital image, a tag defining the image area of the image button, and a tag defining content associated with the image button.

According to a further embodiment, the image area covers an object in the image, and the method further includes storing computer program code for the image button describing type information for the object.

According to a further embodiment, the method further includes storing coordinate data for the image area.

According to a second embodiment of the invention, a method for operating a user interface of an electronic device, includes presenting a photograph as a digital image on a display of the electronic device, wherein a segment of the digital image is defined as an image button which is responsive to activation for carrying out a predefined action, detecting activation of the image button, and carrying out the predetermined action in the electronic device.

According to a further embodiment, an object is depicted in the photograph within the segment defined as the image button, and computer program code is stored for the image button in a memory of the electronic device, including data associated with the object, the step of carrying out the predetermined action includes accessing the memory for retrieving data associated with the object, and presenting information relating to the data on the display.

According to a further embodiment, the object is a person, and the computer program code includes a virtual business card for the person, the method further includes presenting contact information associated with the person on the display.

According to a further embodiment, wherein the stored computer program code includes a communication address associated with the object, the step of carrying out the predetermined action includes presenting the communication address associated with the object on the display.

According to a further embodiment, wherein an object is depicted in the photograph within the segment defined as the image button, and computer program code is stored for the image button in a memory of the electronic device, including a communication address associated with the object, the step of carrying out the predetermined action includes accessing the memory for retrieving the communication address, and initiating communication from the electronic device to the communication address.

According to a third embodiment of the invention, a computer program product for operating a graphical user interface includes computer program code executable by a processor in an electronic device having a display. The computer program code includes a tag including image data for a digital image of a photograph, a tag defining coordinate data for a segment of the digital image as an image button, and a tag defining content associated with the image button, wherein the content includes computer program code for a predefined action to be carried out by the electronic device responsive to detecting activation of the image button.

According to a further embodiment, the segment covers an object in the image, the computer program code further includes a tag defining type information for the object.

According to a further embodiment, the segment covers an object in the image, the computer program code further includes a tag defining the predefined action.

According to a further embodiment, the computer program code further includes a plurality of tags, each defining a plurality of predefined actions.

According to a further embodiment, the action includes accessing a memory of the electronic device for retrieving data associated with the object, and presenting information relating to the data on the display.

According to a further embodiment, the object is a person, and the computer program code includes a virtual business card for the person. The action includes presenting contact information associated with the person on the display.

According to a further embodiment, the computer program product further includes computer program code including a communication address associated with the object. The action includes presenting the communication address associated with the object on the display.

According to a further embodiment, the computer program code includes a communication address associated with the object. The action includes accessing a memory of the electronic device for retrieving the communication address, and initiating communication from the electronic device to the communication address.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIGS. 1A-1C schematically illustrate image segmentation of a picture, performed by a conventional computer program;

FIGS. 2A-2C schematically illustrate creation and use of image buttons in a digital image of persons, by image segmentation in accordance with some embodiments of the present invention;

FIG. 3 illustrates a flow chart of a method for creating an image button according to some embodiments of the invention;

FIG. 4 illustrates a flow chart of a method for using an image button according to some embodiments of the invention;

FIGS. 5A-5B schematically illustrate the use of image buttons in a digital image in an embodiment connected to a game;

FIGS. 6A-6C schematically illustrate creation and use of image buttons in a digital image of controllable home equipment according to some embodiments of the invention;

FIG. 7 schematically illustrate a scenario for using an electronic device to trigger actions related to the home equipment of FIGS. 6A-6C, using image buttons according to some embodiments of the present invention;

FIG. 8 illustrates an image of a desktop including a number of items which may be segmented and linked to actions to form image buttons according to some embodiments of the present invention;

FIG. 9 schematically illustrates creation of an image button using selectable items to define the image field of the image button according to some embodiments of the present invention;

FIGS. 10A and 10B illustrate resulting image buttons defined by different embodiment of the process described in FIG. 9; and

FIG. 11 schematically illustrates a graphical user interface system of an electronic device, on which image buttons may be operated according to some embodiments of the present invention may be operated.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present description relates to the field of electronic devices including a display for presentation of images, and also having a control handling mechanism capable of detecting and handling user input signals according to defined schemes. Typically, such a control handling mechanism includes a microprocessor system, including associated memory and software, devised to detect input signals and initiate actions dependent on such signals, such as setting up a connection responsive to a lift phone command, presenting a symbol on the display responsive to depressing a key bearing that symbol, and so on. Embodiments of the present inventions are described herein as usable in electronic devices in the form of mobile phones. However, it should be noted that other types of electronic devices, comprising a display and a control handling mechanism such as microprocessor system, are useable as platforms for employing embodiments of the invention, including desktop computers, laptop computers, communicators, electronic organizers, PDAs (Personal Digital Assistants), programmable remote controls with display, and digital cameras.

Some embodiments of the invention may stem from the inventors' realization that if one could use a camera to take a picture of a person or moment and use this picture as an enabler for managing and initiate events representing real world actions this could enhance the user experience and add new qualities to the usage of an electronic device. According to some embodiments of the invention, selected objects in an image, such as persons or electronic apparatuses, are separated from each other and the background, and the image area of a separated object is then programmed to act as an image button for user input or output. The image button is responsive to activation by a user. How activation is made is a matter of selecting a technique which is suitable for the application in question. One way is to display the image button on a touch-sensitive display, whereupon activation may be made by clicking on the surface area covered by the image button on the display using a finger, stylus or the like. Another alternative, which may but does not have to include a touch-sensitive display, is to present the image button on a display on which a cursor can be moved by means of a cursor control device, such as a mouse, joystick, jog ball or the like. Activation of the image button is then achieved by placing the cursor within the area covered by the image button, and pressing a selection key, such as a softkey. It is preferably also possible to user a roll-over action to mark two or more image buttons presented on a display, and then activate both or all of the marked image buttons by means of a selection key. The description presented below, the words activating, clicking and pressing will be used at different times. However, it should be noted that, unless specified, this may be performed either by user activation directly on a touch-sensitive display or by using other control means for marking and activating an image button presented on a display, and that the invention is applicable to any such means for activating an image button.

The image button may be linked to information concerning the object represented by the image button, such that it is responsive to activation for presenting such information on a display or audibly. Alternatively, or additionally, the image button may be responsive to activation for setting up a connection with the object represented by the image button. The image button may also be highlighted responsive to other actions besides pressing the image button, e.g. a separated image of one out of a plurality of persons in an image being highlighted to indicate an incoming call from that person. Other examples will be given below.

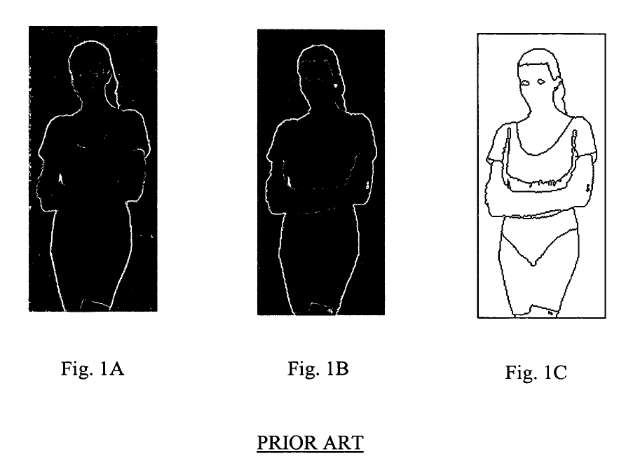

Image segmentation is a fairly mature technique for separating objects in an image from its background. There are several known methods for performing the object separation, for instance threshold techniques, edge-based methods, region-based techniques, connectivity-preserving relaxation methods and face recognition. Several of these techniques can be used in combination with embodiments of the invention. FIG. 1A illustrates a picture of a woman, stored as a digital image. In FIG. 1B the image of FIG. 1A has been segmented using a computer program for color image segmentation. In FIG. 1C the contour image of the segmented image is shown. The prior art computer program used for the segmentation is based on the mean shift algorithm, a simple nonparametric procedure for estimating density gradients, and was provided by Dorin Comaniciu and Peter Meer of the Department of Electrical and Computer Engineering, Rutgers University, Piscataway, N.J. 08855, USA, published in Proceedings of IEEE Conference on Computer Vision and Pattern Recognition, San Juan, Puerto Rico, June 1997, 750-755. Using this technology it is e.g. possible to perform the segmentation of the picture in FIG. 1A to provide the contour information of FIG. 1C, from which it is possible to select and highlight only the eyes of the woman. In the corresponding way, a picture of a plurality of persons may be segmented to separate each of those persons from each other. According to some embodiments of the invention, one or more segmented portions of an image is then linked to data stored in the electronic device, for instance status or information data for the object depicted in the segmented portion, or a command related to that object.

Exemplary embodiments of the invention will now be described with references made to the accompanying drawings.

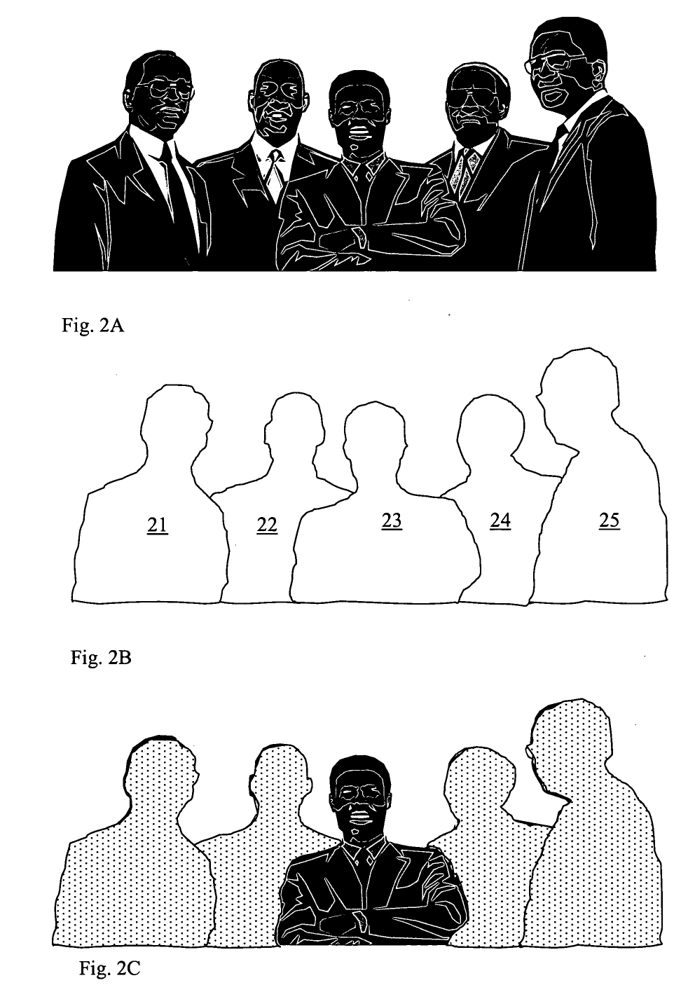

FIG. 2A illustrates, purely schematically, a group image of five people. Using an image segmentation program, separate image portions 21, 22, 23, 24, and 25 are defined, each representing one of the people in the group, as illustrated in FIG. 2B. As can be seen from the example of FIG. 1, more than one segment may be obtained for each person, whereas in the simple example of FIG. 2B there is only one segment per person. This may be obtained by simply selecting all segments covering one person and linking them into one overall segment, in the same way as plural objects in a standard drawing application, such as in Microsoft® Word, may be grouped. The image area of each portion 21-25 is then linked to related data or commands, in order to create five image buttons. In a preferred embodiment, the image button is used together with a touch-sensitive display, such that when the picture of FIG. 2A is presented thereon and one of the defined image portions 21-25 is activated by being pressed, information or actions related to the object of that image portion is presented or triggered. In an alternative embodiment, not requiring a touch-sensitive display, activation of the image button is effected by placing a display cursor steered by a cursor control device such as a mouse, joystick, jog ball or the like, on the image portion of the image button, and pressing a selection key.

In FIG. 2C image portion 23, indicating the middle person, has been selected. Responsive to this selection, image portion 23 is highlighted over the other image portions. The highlighting may be achieved by fading, blurring or darkening the non-selected image portions and possibly the entire background. Activation of an image button may trigger different actions dependent on the situation, and different examples will be given below.

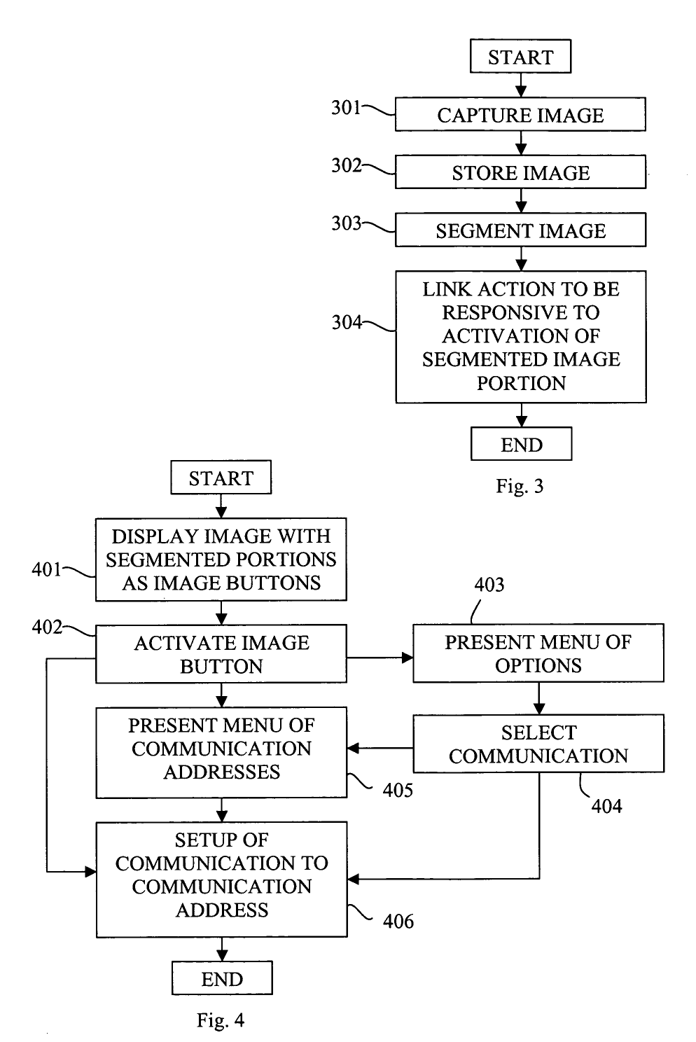

FIG. 3 illustrates schematically the major process steps of creating an image button.

In step 301 an image is captured, using a digital camera or an analog camera and subsequently digitizing the analog picture, for providing a digital image.

In step 302 the image is stored in an electronic device having a display, such as a computer or a mobile phone. The camera used to capture the image may also be included in that electronic device.

In step 303 the digital image is segmented, in order to separate image portions representing different objects in the image from each other or from their background. This is performed using an image segmentation computer program, which as such is a well known technology.

In step 304 one or more actions are linked to separated image portions, wherein the separated image portion will act as an image button by defining a field in the image which may be activated for automatically performing the linked action. The action may be mere presentation of information, or issuing of a command to initiate e.g. a call.

In electronic communication devices, such as mobile phones or network-connected computers, contact information to other people is often stored and sorted in contact list, such as electronic phone books. Contact information stored in such a contact list typically includes phone numbers and email addresses. In one embodiment, such a contact list is linked to image buttons in accordance with some embodiments of the invention. An example of such an embodiment is described with reference to FIGS. 2-4.

Five members of a certain group, such as a company department, are captured in a picture as in FIG. 2A. The image is stored in an electronic device, which may also have been used to capture the image, such as a mobile phone with a built in camera.

Segmentation of the digital image is performed to identify separate image buttons for each of the five persons as in FIG. 2B. Preferably, the computer program used for image segmentation is also adapted to make segmentation suggestions, by eliminating or combining details smaller than a predefined pixel size, and concentrating on defining large details. This is a manner of simple settings in the computer program code, which can be easily made by a skilled person.

Each image button is linked to a position in a contact list stored in or linked to the electronic device. The action of the image button is then programmed such that activation of the image button, e.g. by clicking thereon, automatically sets up a communication connection directed to the person depicted on that image button, by e.g. placing a telephone call to a pre-stored telephone number or opening a new email message addressed to that person, as defined in the contact list.

FIG. 4 illustrates one way of using the image button for the situation outlined in this example.

In step 401 an image which has been prepared in accordance with some embodiments of the invention as given with reference to FIG. 3, including one or more image buttons, is presented on a display of an electronic device. It should be noted here that it is not necessary that the image with the image buttons is actually used in the electronic device in which they are created. On the contrary, the image buttons may well be shared to other users and devices, as will be explained in more detail.

In step 402 one image button is activated, either by direct pressing on the image portion defining the image button on the display if it is a touch-sensitive display, or by using a cursor and a selection button. This activation triggers the action linked to the image button.

A simple embodiment goes directly to step 406, in which automatic setup of a communication to a preset communication address is initiated. This may be setting up of a telephone call, or opening a text message window addressed to a network address. Typically, the communication address is an address of a person represented in the image portion defining the image button.

Nowadays there are many different ways of communicating with other people, using ordinary telephony, mobile telephony, facsimile, email, SMS, MMS, IP telephony and so on. In one embodiment, represented in step 405, activation of the image button as in step 402 is therefore devised to present a menu with usable options, such as different means and addresses for contacting the person in question, after which one of those options may be selected. After selecting of one of the options the process then continues with step 406.

In a more general embodiment, the first activation of the image button in step 402 generates the action of presentation of a menu in step 403, containing a number of options, of which one may be to setup communication.

Selecting that option in step 404 leads either to step 405 or 406, dependent on if the person represented on the image button has more than one communication address, and if the application software for handling the image button is programmed to first show the menu of step 405 or proceed directly to one preset communication address in step 405.

Providing and using a contact list linked to a picture provides a visually appealing and intuitive way of keeping track of contact information. A user may e.g. want to send a message to a number of people of a group. If that group is gathered in an image, such as the image of FIG. 2A, which is segmented and stored in a user's electronic device, that user may write a text message and then address and send the message to a selectable subset of people in the group by activating the image buttons of the recipients of interest.

In a corresponding way, a telephone call may be setup to plural recipients by using the image buttons. As an example, a special key or a softkey adapted for this purpose, may be used as the shift button on a standard PC keyboard. Thus, by holding down the special key and then activating a selected number of image buttons, that selected number of image buttons will be highlighted and either directly activated or activated after pressing a confirmation key. Activation of a plurality of keys sets up a telephone communication link to the persons depicted on the selected image buttons, provided they are available and respond to the call. This may e.g. be used for setting up a conference call to multiple conference participants. Alternatively, a PTT (Push-To-Talk) connection is setup to the selected persons. This way, one person at a time of the initiating party and the persons called by that party, may talk at once while the other ones may listen.

In accordance with one embodiment of the invention, the image buttons are also used for indicating an incoming message, such as a telephone call or a text message. If the communication address of an incoming message is previously stored in a contact list of the receiving electronic device, an image button linked to that communication address may be triggered to be presented on the display of the electronic device, preferably together with an audible signal.

Further embodiments linking the image button feature to a contact list of an electronic communication device may include positioning. Provided that a user has been given the right to obtain position information for some group of other users, such as a set of friends, position information may be requested or automatically sent to the device of the inquiring user. When the position information is received, a segmented image such as the one in FIG. 2C may be used for highlighting the persons of the group which have been found to be present within a preset area, such as within the coverage area of the same communication network cell.

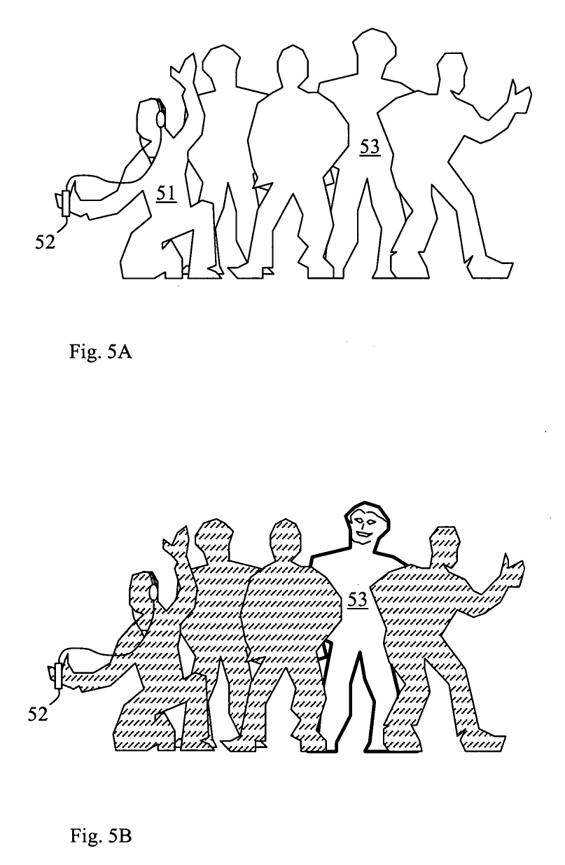

In another embodiment of the invention, image buttons may be used by network operators or service providers for gaming, marketing and presentation of information. One example of such an embodiment is described with reference to FIGS. 5A and 5B.

In FIG. 5A some members of a sports team are schematically illustrated, though not as detailed as in FIG. 2A. The team is sponsored by a manufacturer of mp3 players, and the picture of FIG. 5A shows a team member 51 carrying one of their own mp3 player models 52. The image of FIG. 5A is segmented and subsequently one or more of the separated image portion covering the respective team players are linked to one or more actions in accordance with some embodiments of the invention, and the segmented and linked image is used for marketing purposes. As an example, the manufacturer may arrange a combined lottery and advertisement campaign, by distributing the digital segmented and data linked image. A user may receive the image of FIG. 5A in an MMS, and view it on the display of an electronic device, such as a mobile phone. A text string is displayed along with the image, which may present the mp3 model 52, the manufacturing company, and the depicted excellent team they sponsor. Furthermore, the text string would include a contest provided by means of a question, which can be answered by activating one of the image buttons. Typically, the question may be “Who scored most goals last season? Think hard and press your choice! Cost [symbol] 1”.

In FIG. 5B, the user handling the electronic device on which the image is presented has made a choice by pressing image button 53, which happens to be the correct answer. The activation of image button 53 triggers a predefined action linked thereto. Typically, activation may trigger the image portion 53 of the selected player to be highlighted, as indicated in the drawing, and also presentation of the result of the users selection in the form of a text string or audio message, such as: “Yes, John Smith is the right player! You have won our new mp3 player.” Actual addressing and delivery of the item may be solved in many ways. The activation of an image button should preferably also automatically trigger debiting of the indicated amount. There are different known ways of handling debiting of network services, and if the contest is provided by or in agreement with the network operator, the cost may be added to the standard subscription account of the user.

In another embodiment of the invention, a segmented image may be used as a digital invitation card. For instance, an invitation to a class reunion may include an original image of the graduation photo, in which each student has been segmented out to provide an image button for each person, where after information has been linked to each image button, such as name, present place of residence and occupation, and so on. The information related to a certain student is thereby automatically retrieved and presented when the image button covering that student is activated, e.g. by clicking.

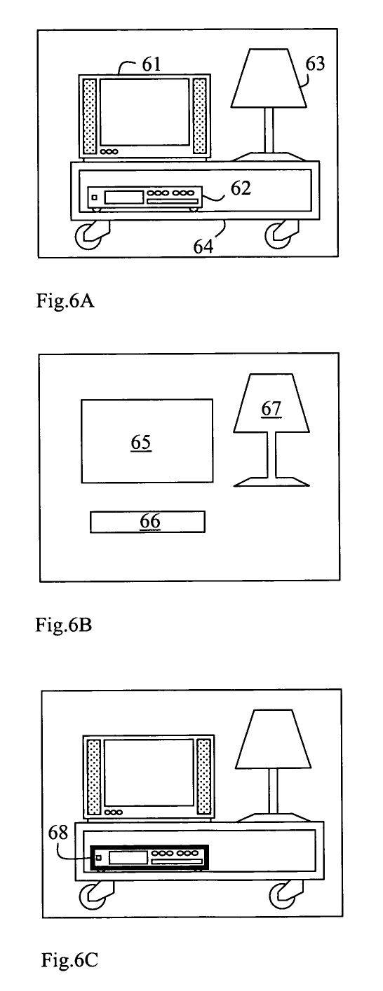

In an alternative embodiment, the image buttons are used for objects other than persons. FIG. 6A illustrates a picture taken of a television set 61, a DVD recorder 62 connected to the television 61, and a lamp 63 placed on a television table 64. The picture is stored as a digital image, and is subsequently segmented to identify one image button 65 for the television set 61, one image button 66 for the DVD recorder 62, and one image button 67 for the lamp 63. Different actions are then linked to each image button. Typically, the first action to be triggered when activating one of the buttons would be to present a menu of options related to the object of the image button, as described with reference to step 403 in the general process above. For image button 65 the menu could e.g. include on/off and channel selection for television set 61. For image button 66 the menu could include on/off, play/stop/skip, and a menu item for programming the DVD recorder 62 to read and store a media signal with certain timing criteria. For image button 67 the menu could include on/off and a timer function.

The image buttons 65-67 may be visible in the image of FIG. 6A, e.g. as thin contours, or completely invisible. When one of the image buttons are selected by activating it, such as image button 66, the corresponding button is preferably highlighted in the image, e.g. by a frame as in FIG. 6C. At the same time, the associated menu is presented (not shown) in or adjacent to the image of FIG. 6C, or on another the display of the same electronic device.

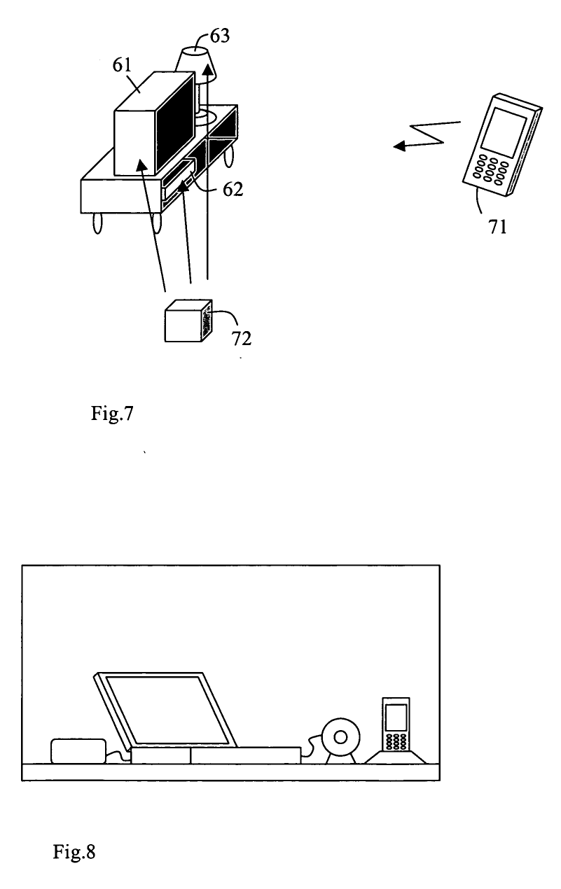

FIG. 7 illustrates schematically how image buttons as described in conjunction with FIGS. 6A-6C may be used. A user has an electronic device 71, which includes a display, a user input interface in the form of keys and cursor control mechanism or a touch-sensitive display, a data processing system for triggering actions responsive to user input selections, and signal transceiver means. Typically, electronic device 71 is a mobile phone, adapted to communicate not only via a mobile network of base stations, such as a GSM or WCDMA network, but also via short distance wireless communication such as WLAN, or direct wireless communication such as through IR or radio using e.g. bluetooth. The image of FIG. 6A is stored in electronic device 71, together with associated control data which links preset actions to the separate image buttons 65-67. The user may display the image containing the image buttons on the display of electronic device 71. Activating one of the image buttons will then trigger the associated action. The action selected also includes sending a signal to the control or retrieve information from the object represented by the image button. For instance, if the television button 65 is activated, e.g. by being clicked, and power on is selected, automatically or after selection in a menu presented in the display of electronic device 71, electronic device 71 has to relay the power on command to the television set 61. This may be performed by connecting sending a signal using the transceiver means of the electronic device 71, directly to signal receiving means, typically an antenna and associated electronics, in the television set 61. Alternatively, a signal relay station 72, such as a router, hub or switch, may receive the signal from electronic device 71. The relay station 72 then, by wire-bound or wireless connection, sends the power on signal to the television set 61. In the same manner, electronic device 71 may be used to control DVD recorder 62 when your away from home, to record a show you do not want to miss, or e.g. control the lamp 63 and possibly also the television 61 to be turned on between selected evening hours to discourage potential burglars. Relay station 72 may be connected to the home telephone line, and thereby also be connectable through the Internet. Furthermore, relay station 72 preferably also has signal transmission capabilities, such that status information for the objects 61-63 may be sent to the electronic device 71 for presentation to the user.

FIG. 8 illustrates another embodiment, in an image of a user's desktop. The image includes a computer 81, a modem 82, a web camera 83, and a mobile phone 84 including a digital camera, placed in holder. In accordance with some embodiments of the invention, these different objects may be segmented and linked to different actions, as image buttons. One such action for the mobile phone 83 may e.g. be to send an image to computer 81.

The same electronic device may consequently be used as a remote control device for many different apparatuses, such as those shown in FIGS. 7 and 8. It is well known that the more complex and diversified an electronic device is, the more difficult is it to sort and present different possible usable applications in a clear manner, and to browse large menus in many different levels is both time consuming and a cause for mistakes since menu items generally are very brief. This is particularly the case for compact devices, such as mobile phones, which have comparatively small displays. Some embodiments of the invention provide a solution for a graphical user interface which combines the intuitive and straightforward manner feature of images with built in buttons, preset to lead either directly to linked actions, or to the correct submenu relating to the object depicted on the image button.

By using a well known image segmentation technique for separating objects in an image, for instance people can be segmented. By storing the coordinates of a segmented area as a polygon it can at a later stage be used to mark or identify that area in the image. If you use this picture and the area information it is possible to create buttons that can be used for a touch screen or normal screen. The entire image can then be saved in a format that describes the areas of the objects and also includes information of the specific object, for instance an IP number if the object is a computer or a vCard if the object is a person. Quality of service and other functionalities can of course be included as well. After defining object areas in the image the image can be stored in an xml-like format which contains the image itself and the buttons.

Adding images to an xml document can be performed by coding the image in a Base 64 binary format. The different buttons can stored in the xml file as a button tag, such as the image buttons of FIG. 2B or 6B. A specific “Image Button Creator”-parser is then needed when the data should be extracted from the file. With the information parsed from the xml-file the image with its buttons highlighted can be displayed. From the parsed action functionality is added to the buttons.

The following is an example of a button file.

```
This is the start tag for the xml file containing the buttons:
<createdButtons>
  This tag contains the actual image in base64 coded format:
    <button_image dt:dt=“binary. base64”>
450394gvi98sklv743mv934jhdf4j</button_image>
    Here are the button tags:
    <button> . . . </button>
    <button> . . . </button>
    . . .
  This is the end tag for the xml file containing the buttons:
  </createdButtons>
```

The following is an example of a button connected to a person, such as buttons 21-25:

```
<button>
  This tag describes the area of the button, for instance a polygon with its
  coordinates:
  <buttonarea>10,15, 11,18, 13,17, 17,12</buttonarea>
  This is the start tag for describing the content of the button:
  <content>
    This describes what type of object that is connected to the button, in
    this case a person:
    <objectType>person</objectType>
    The person's vCard information:
    <vCard>
      BEGIN:VCARD
      VERSION:2.1
      N: Smith; John
      TEL;WORK:+4646123456
      TEL;HOME:+4646789101
      EMAIL;INTERNET;PREF:john@johnsmith.com
      TEL; CELL:+46701234567
      END:VCARD
    </vCard>
    The actions connected to this button
    <nbrOfActions>12</nbrOfActions>
    <action>voiceCall</action>
    <action>videoCall</action>
    <action> InstantMessage </action>
    <action>SMS</action>
    <action>MMS</action>
    <action>e-mail</action>
    <action>deleteObject</action>
    <action>addAction</action>
    <action>removeAction</action>
    <action>activate Button</action>
    <action>deactivate Button</action>
  </content>
<button>
```

The following is an example of a button connected to a laptop computer:

```
<button>
  <buttonarea>10,15, 11,18, 13,17, 17,12</buttonarea>
  <content>
    <objectType>laptop</objectType>
    <objectDescription>
      <computerName>LittlePapa</computerName>
      <IP_Address>10.123.456.789</IP_Address>
      < Bluetooth_Address >aAAFFEEDBAC</Bluetooth_Address>
    </objectDescription>
    <nbrOfActions>9</nbrOfActions>
    <action>ExchangeFiles</action>
    <action>Remote Control</action>
    <action>RemoreScreen</action>
    <action>deleteObject</action>
    <action>addAction</action>
    <action>removeAction</action>
    <action>activate Button</action>
    <action>deactivate Button</action>
  </content>
<button>
```

In one embodiment, a created xml button file is transferred from one electronic device to another, for use also in the latter electronic device. As an example, a person A has created a button file comprising a button image presentable on a display of a mobile phone, and one or more separate button areas within the image, having associated content. The code of the button file hence determines which action is to be triggered responsive to activation of the image button(s). Person A has created the image button in question from a digital photograph of a number of friends, and wants those friends to be able to use the same type of interface for calling, messaging or retrieving information about the persons in that group. Person A therefore creates a digital message, such as an MMS or an email with the button file as an attachment, and sends it over a mobile phone network to at least a person B among the depicted friends. Once received in the mobile phone of person B, person B installs the software of the button file. By means of code included in the button file, or by manual adjustment, the image button now received is linked to the contact list in the mobile phone of person B, and is thus ready to be used.

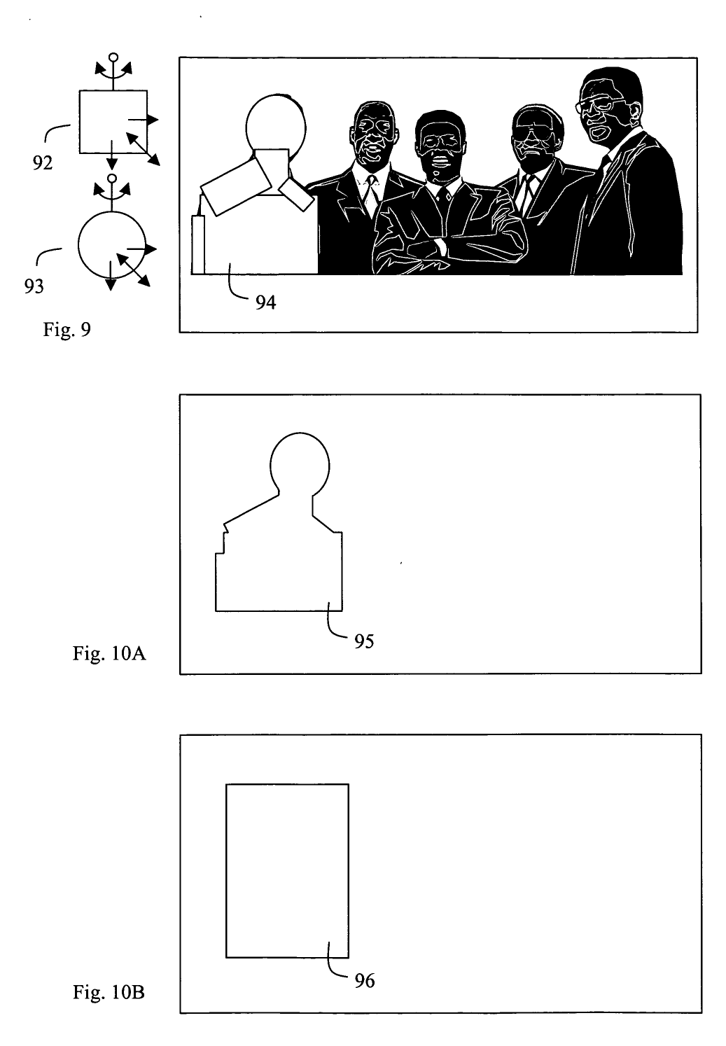

In an embodiment of the invention, a manual solution for identifying the image button areas is employed. If no image segmentation or face recognition technique is accessible or does not work for some reason, a user is presented to a frame or a set of frames of different shapes instead. These frames may for instance be circles, squares, rectangles, which are scalable or provided in different sizes, that can be applied to the image. This makes it is possible to still make an image button from a selection of an image. FIG. 9 illustrates schematically a picture 91, similar to the one of FIG. 2A, as shown on the display of an electronic device set in an image button creator mode. In this case there is no available image segmentation software in the electronic device, and instead a number of usable image area marking frames have been shown on the display. These frames include a rectangle 92 and an oval 93, which may be shaped, scaled and rotated. In the image 91, a user has used the selectable frames 92 and 93 to cover the image portion of the person to the left by a number of frames 94, for the purpose of creating a field for an image button. In the subsequent step the frames 94 used are linked together to one image field 95, as shown in FIG. 10A, preferably by making a “link frames” command in the image button creator application. The aggregated field 95 now defines the area of the image button for the person to the left, to which image button actions such as presentation of information or triggering of events are to be linked in accordance with some embodiments of the invention. Typically, all objects, or persons as in this case, of the image may be separately formed into image buttons, by repeating the process of FIGS. 9 and 10. In a less complex and easier to use embodiment, only one frame 92 is given, such as a rectangle. The frame may or may not be scalable. In FIG. 10B an embodiment is shown where a single frame 96 has been placed and scaled in height and width to suit the person to the left as good as possible. Even though that frame may not follow the contour of the image area to which the image button relates perfectly, it still offers an advantageous solution. Preferably, the image button be is highlighted when marked by a cursor or the like, and it will be evident that the image button in question relates to the person which occupies basically the entire area of the image button.

In yet another embodiment, defining the image area of the image button may be performed by drawing a contour for the image button in the image when presented on a display. For a touch-sensitive display, this may be performed by moving a stylus or a finger of the display. An alternative is to use a cursor and a cursor control device, such as a mouse or joystick.

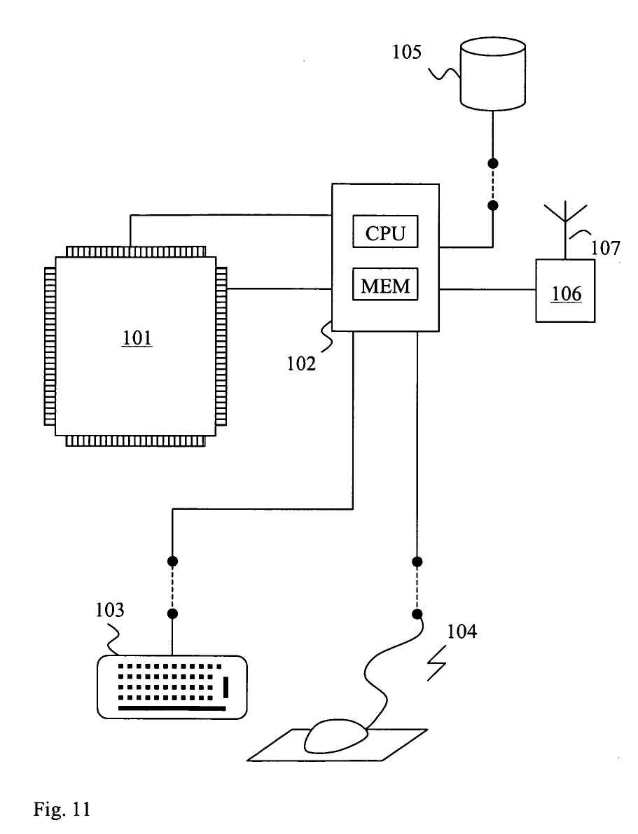

FIG. 11 schematically discloses a graphical user interface of an electronic device with, on which the method for using image buttons according to some embodiments of the invention may be used. The electronic device may e.g. be a mobile phone or a computer. A display 101 is communicatively connected to a microprocessor unit 102, which in turn includes at least a computer processor CPU and an internal memory MEM. Hardware of the microprocessor unit is further associated with a computer program product comprising software for handling presentation of information on the display 101, by use of a graphical user interface according to some embodiments of the invention, and software for detecting clicking on segments of digital images presented on the display and performing predetermined actions responsive to detected clicking. In order to input data to the microprocessor unit 102, e.g. for creating image buttons or for operating the electronic device, some form of data input means are connected thereto, for instance a key board or a key pad 103 and/or a cursor control device 104 such as a mouse, a track ball or a joy stick. The microprocessor unit 102 may also be connectable to a an external memory or database 105, in the embodiment of the communication terminal such as a mobile phone, memory 105 may be or correspond to a subscriber identification module SIM connectable to the terminal. According to some embodiments of the invention, the computer program product comprises computer program code which can be stored in the memory MEM of the microprocessor unit 102 and which, when executed by the microprocessor unit, triggers the microprocessor unit to present a graphical user interface on display 101 with image buttons responsive to clicking, according to what has been described in relation to the preceding drawings. The microprocessor unit 102 is preferably connected to a transceiver unit 106 for sending and receiving data. A transmission device is preferably connected to transceiver unit 106, such as an antenna 107 for radio communication, or optionally a cable connector for cord connection to another electronic device, a memory stick interface, or an IR interface.

Various embodiments of the invention have been described by means of suitable method steps and modes of operation for creating and using image buttons in different embodiments. Some embodiments of the invention may make it easy and straightforward to use familiar elements from our surrounding and make them into buttons or action areas. Digital or real world object or images can enhance user experience. Especially in connection with touch screens it would give a more direct interaction than many other solutions has and gives a personal touch to graphical user interfaces. This can be used for connecting actions to an individual or a group to support communication and for example improve vCard functionality.

Some embodiments of the invention may advantageously be used for capturing and storing information related to random or short term encounters. A person may for example temporarily travel together with a group of people, which soon after would risk to be forgotten. Traditionally, you take a photo of your temporary friends and exchange phone numbers or addresses for future use. However, the photo may be lost and the person behind the contact information stored in your mobile phone or written on a piece of paper tend to fade. This way, some embodiments of the invention provide a unique solution for linking images with information related to the persons or objects included in the images. Capturing a digital image of a group of friends, segmenting the image to create image buttons, and then adding identity and contact information to the persons, means that that the image and the information are linked and stored together. The button file can then be sent to a place for safe storage, such as to a computer back home, and also to the other persons in the picture. This way, the risk of losing or forgetting information about the persons is minimized. Furthermore, a simple sharing function is preferably included, which is usable for this scenario. By marking all image buttons in an image and giving a sharing command, e.g. by using a soft key and selecting a “share to all” command in a menu, the image with the image buttons is automatically sent to all contacts present in the image. The transmission may be preset to be achieved to a certain address type, such as by email or MMS, or this selection option could be given to the user responsive to making the share to all command. Apart from being an attractive way of using a camera of a mobile phone, embodiments of the invention are also useful for non text based interaction e.g. for people who cannot read or children. Furthermore, the use of images bridges any language barrier in a very efficient way, and embodiments of the invention may be therefore extremely well suited for the increasingly global community.

Described embodiments include presentation of, or direct connection to, a communication addresses for a person depicted in a defined image button. It should be noted, though, that also other types of objects may have associated communication addresses too, such as a depicted communication device having an associated telephone number, bluetooth address or IP address, or e.g. a building for a company or association which has telephone numbers, email addresses, facsimile numbers, and so on.

What is claimed is:

1. A method for creating a user interface for an electronic device, comprising:
providing a photograph as a digital image;
defining an image area which is a segment of the digital image; and
defining an image button by linking an action to the image area, to be carried out responsive to activation of the image area when the image is presented on a display.

2. A method according to claim 1, wherein defining said image area comprises:
running an image segmentation application on the digital image to define separate segments covering objects depicted in the photograph; and
selecting a segment identified by said image segmentation as said image area.

3. A method according to claim 1, wherein defining said image area comprises:
placing one or more image area marking items in the image; and
defining the image area as the area covered by said one or more image area marking items.

4. A method according to claim 1, wherein an object is depicted in the image area of the image button, and further comprising storing computer program code for the image button, including data associated with said object.

5. A method according to claim 4, wherein said action comprises presentation of information relating to said data associated with said object.

6. A method according to claim 4, wherein said information comprises a communication address associated with said object.

7. A method according to claim 4, wherein said data comprises a communication address associated with said object, and said action to be carried out comprises initiating communication from the electronic device to said communication address.

8. A method according to claim 4, wherein said object is a person, and said computer program code comprises a virtual business card for said person.

9. A method according to claim 1, further comprising storing computer program code comprising a tag with image data for the digital image, a tag defining the image area of the image button, and a tag defining content associated with the image button.

10. A method according to claim 9, wherein said image area covers an object in the image, the method further comprising storing computer program code for the image button describing type information for said object.

11. A method according to claim 9, further comprising storing coordinate data for the image area.

12. A method for operating a user interface of an electronic device, comprising:
presenting a photograph as a digital image on a display of the electronic device, wherein a segment of the digital image is defined as an image button which is responsive to activation for carrying out a predefined action;
detecting activation of the image button; and
carrying out said predetermined action in said electronic device.

13. A method according to claim 12, wherein an object is depicted in the photograph within the segment defined as the image button, and computer program code is stored for the image button in a memory of the electronic device, including data associated with said object, wherein the step of carrying out said predetermined action comprises:
accessing said memory for retrieving data associated with said object; and
presenting information relating to said data on said display.

14. A method according to claim 13, wherein said object is a person, and said computer program code comprises a virtual business card for said person, the method further comprising presenting contact information associated with said person on said display.

15. A method according to claim 13, wherein the stored computer program code includes a communication address associated with said object, the step of carrying out said predetermined action comprising presenting said communication address associated with said object on said display.

16. A method according to claim 12, wherein an object is depicted in the photograph within the segment defined as the image button, and computer program code is stored for the image button in a memory of the electronic device, including a communication address associated with said object, wherein the step of carrying out said predetermined action comprises:
accessing said memory for retrieving said communication address; and
initiating communication from the electronic device to said communication address.

17. A computer program product for operating a graphical user interface, the computer program product comprising computer program code executable by a processor in an electronic device having a display, the computer program code comprising:
a tag including image data for a digital image of a photograph;
a tag defining coordinate data for a segment of the digital image as an image button; and
a tag defining content associated with the image button, wherein said content comprises computer program code for a predefined action to be carried out by said electronic device responsive to detecting activation of the image button.

18. A computer program product according to claim 17, wherein said segment covers an object in the image, the computer program code further comprising a tag defining type information for said object.

19. A computer program product according to claim 17, wherein said segment covers an object in the image, the computer program code further comprising a tag defining said predefined action.

20. A computer program product according to claim 19, the computer program code further comprising a plurality of tags, each defining a plurality of predefined actions.

21. A computer program product according to claim 19, wherein said action comprises:
accessing a memory of the electronic device for retrieving data associated with said object; and
presenting information relating to said data on said display.

22. A computer program product according to claim 19, wherein said object is a person, and said computer program code includes a virtual business card for said person, wherein said action comprises presenting contact information associated with said person on said display.

23. A computer program product according to claim 19, further comprising computer program code including a communication address associated with said object, wherein said action comprises presenting said communication address associated with said object on said display.

24. A computer program product according to claim 19, further comprising computer program code including a communication address associated with said object, wherein said action comprises:
accessing a memory of the electronic device for retrieving said communication address; and
initiating communication from the electronic device to said communication address.
